(19) United States
(12) Patent Application Publication
(10) Pub. No.: US 2007/0165428 A1
(43) Pub. Date: Jul. 19, 2007

(54) Digital pulse width modulation controlling system and method

(75) Inventors: Yi-Chan Lin, Hsinchu (TW); Yueh-Mei Hou, Hsinchu (TW); Chien-Feng Lai, Hsinchu (TW); Yi-Chen Liu, Hsinchu (TW)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Holtek Semiconductor Inc., Hsinchu (TW)

(21) Appl. No.: 11/370,632

(22) Filed: Mar. 8, 2006

(30) Foreign Application Priority Data
Jan. 16, 2006 (TW) 95101650

(51) Int. Cl. H02M 1/12

(52) U.S. Cl. 363/41

(57) ABSTRACT

A digital pulse width modulation (DPWM) controlling system for controlling a load of an application circuit with a DPWM unit is provided, which comprises a comparator and a micro-control unit, the comparator receiving a sense signal detected from the load and a reference signal and comparing the sense signal and the reference signal to output an analog comparison signal, and the micro-control unit generating a trigger signal having a minimum pulse width and receiving the analog comparison signal to output a DPWM signal, wherein the micro-control unit adjusts the minimum pulse width of the trigger signal to obtain a pulse width of the DPWM signal in response to the analog comparison signal whenever the sense signal is within a stable duration so as to output the DPWM signal to the application circuit to control the load.

### FIELD OF THE INVENTION

The present invention relates to a digital pulse width modulation (DPWM) controlling system and method. More particularly, the present invention relates to a DPWM controlling system and method without the need of an analog-to-digital (ADC) converter.

### BACKGROUND OF THE INVENTION

The pulse width modulation (PWM) controlling system is a system usually used for controlling an electronic device. In essence, an output signal on a load of the electronic device is first detected as a sense signal. Then, the sense signal is compared with a reference signal to obtain a comparison result. Then, a predetermined pulse width is formed as a signal based on the comparison result to serve as a PWM signal by which the electronic device is controlled. Correspondingly, the load is controlled via the electronic device. Namely, the PWM control signal is adjusted by means of the negative feedback technology and then the adjusted PWM control signal is issued to control the electronic device and thus the load.

Generally, such PWM system comprises an analog PWM (APWM) system and a digital PWM (DPWM) controlling system. FIG. 1 and FIG. 2 are functional diagrams of the APWM and DPWM systems, respectively. As shown in FIG. 1, a sense signal Vsense and a reference signal Vref are inputted to a comparator 11 for comparison, and a comparison signal Vcmp is outputted from the comparator 11 according to the comparison result. Next, the output signal Vcmp of the comparator 11 is compared with a ramp signal Vramp at another comparator 12 to output a PWM signal VPWm with a fixed frequency and a variable duration. Then, the PWM signal V_{PWM} is transmitted to control the electronic device and thus the load thereof (not shown). However, the frequency of the ramp signal Vramp is not stable, causing the whole control system 10 to be vulnerable to noises. To solve this problem, a resistor and capacitor are generally introduced to serve for frequency compensation. However, the additional elements generally bring to a higher cost. In response to this problem, the DPWM controlling system is set forth, shown in FIG. 2. In contrast to the APWM controlling system, the DPWM controlling system 20 generates the PWM control signal V_{PWM} associated with the sense signal Vsense by virtue of a comparator 21, an analog/digital converter (ADC) 22, a micro-control unit 23 and a PWM control unit 24. Since the frequency inconsistency issue is not involved with the DPWM controlling system, it is substantially immune to noises, saving the requirement of the additional elements as above mentioned. Accordingly, the DPWM controlling technology has become a mainstream in the PWM controlling field. However, the DPWM controlling system requires the ADC to converse an analog signal to a digital signal, requiring a higher resolution with respect to the bit number used when a higher precision of the control signal is to be achieved. As such, an increased data amount has to be processed in the controlling system, increasing design complexity and cost expenditure of the controlling system.

In view of the above, there is a need to provide a DPWM controlling system and method with a reduced cost and an enhanced processing efficiency, so as to address the problems encountered in the prior art.

After a long intensive series of experiments and researches, the inventor finally sets forth a DPM controlling system and method of the present invention, which may effectively overcome the problems existing in the prior art.

### SUMMARY OF THE INVENTION

It is, therefore, an object of the present invention to provide a digital pulse width modulation (DPWM) controlling system and method so as to obviate the problems inherent in the prior art.

In accordance with an aspect of the present invention, a DPWM controlling system for controlling a load of an application circuit with a DPWM unit is disclosed, which comprises a comparator and a micro-control unit, the comparator receiving a sense signal detected from the load and a reference signal and comparing the sense signal and the reference signal to output an analog comparison signal, and the micro-control unit generating a trigger signal having a minimum pulse width and receiving the analog comparison signal to output a DPWM signal, wherein the micro-control unit adjusts the minimum pulse width of the trigger signal to obtain a pulse width of the DPWM signal in response to the analog comparison signal whenever the sense signal is within a stable duration so as to output the DPWM signal to the application circuit to control the load.

Preferably, the micro-control unit comprises a storage medium performing the steps of, when executed, counting a respective number of times of a high level and a low level occurring on the analog comparison signal, respectively, whenever the sense signal is within the stable duration, generating a portion of the DPWM signal according to the respective number of times of the high level and the low level whenever the sense signal is within the stable duration, and repeating the counting and generating steps to obtain a plurality of portions of the DPWM signal to output continuously the DPWM signal by combining the plurality of portions of the DPWM signal. The stable duration is a duration from a predetermined point of time after the portion of the DPWM signal begins to a point of time before an intermediate next portion of the DPWM signal begins. The predetermined point of time is a point of time when twenty percents of the duration, from the point of time when the portion of the DPWM signal begins to the point of time before the intermediate next portion of the DPWM signal begins, is reached. The counting step comprises the step of sampling the analog comparison signal to generate the high level and the low level. The generating step comprises the steps of increasing continuously the pulse width of the DPWM signal when the number of times of the high level is greater than the number of times of the low level, and decreasing continuously the pulse width of the DPWM signal when the number of times of the low level is greater than the time of the high level. The trigger signal is sent back to the micro-control unit when the DPWM signal transitions from the high level to the low level.

In accordance with another aspect of the present invention, a DPWM controlling method for controlling a load of an application circuit with a DPWM unit, which comprises the steps of receiving a sense signal detected from the load and a reference signal; comparing the sense signal and the reference signal to output an analog comparison signal; counting times of a high level and a low level occurring on the analog comparison signal, respectively, whenever the sense signal is within a stable duration; generating a portion of the DPWM signal having a specific pulse width according to the times of the high level and the low level whenever the sense signal is within a stable duration; and repeating the counting and generating steps to obtain a plurality of portions of the DPWM signal to output continuously the DPWM signal by combining the plurality of portions of the DPWM signal.

Preferably, the stable duration is a duration from a predetermined point of time after the portion of the DPWM begins to a point of time before an intermediate next portion of the DPWM signal begins. The predetermined point of time is a point of time when twenty percent of the duration from the time after the portion of the DPWM signal begins to the intermediate next portion of the DPWM signal begins is reached. The counting step comprises the step of sampling the analog comparison signal to generate the high level and the low level. The generating step comprises the steps of increasing continuously the specific pulse width of the DPWM signal when the time of the high level is greater than the time of the low level, and decreasing continuously the specific pulse width of the DPWM signal when the time of the low level is greater than the time of the high level.

With execution of the inventive DPWM controlling system and method, the control of the load of the electronic device can be efficiently and effectively achieved. Thus, the demerits existing in the prior art may be eliminated.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods and disclosed or illustrated. In the drawings:

FIG. 1 is a functional diagram of a conventional analog pulse width modulation (APWM) controlling system;

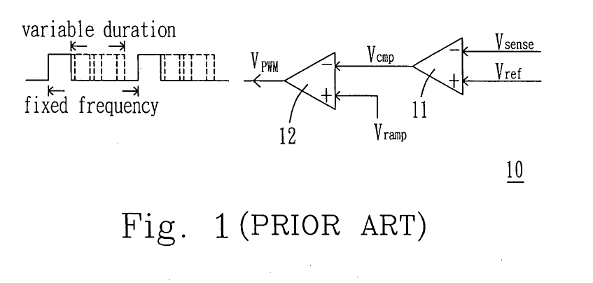

FIG. 2 is a functional diagram of a conventional digital pulse width modulation (DPWM) controlling system;

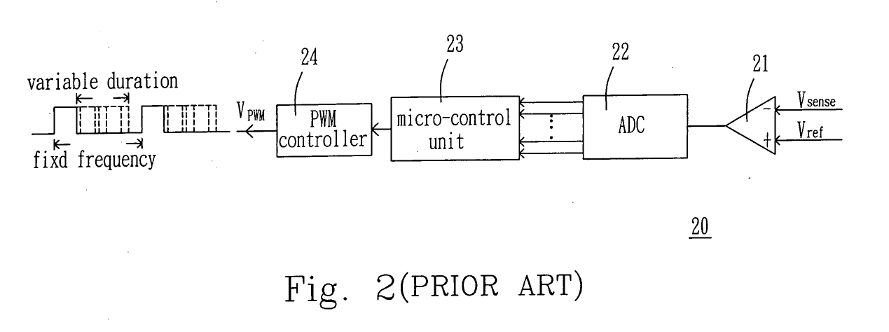

FIG. 3 is a schematic circuit diagram of a digital pulse width modulation (DPWM) controlling system according to the present invention;

FIG. 4 is an illustrative circuit diagram of the circuit shown in FIG. 3;

FIG. 5 is a schematic circuit diagram of the DPWM controlling system with a voltage boost circuit according to the present invention;

FIG. 6 is a schematic circuit diagram of the DPWM controlling system with a voltage buck circuit according to the present invention;

FIG. 7 is a schematic circuit diagram of the DPWM controlling system with a voltage boost/buck circuit according to the present invention; and

FIG. 8 is a flowchart illustrating a DPWM controlling method according to the present invention.

### DETAILED DESCRIPTION OF THE PREFERRED EMBODIMENT

The present invention discloses a digital pulse width modulation (DPWM) controlling system and method, which will be described through the preferred embodiments with reference to the appended drawings.

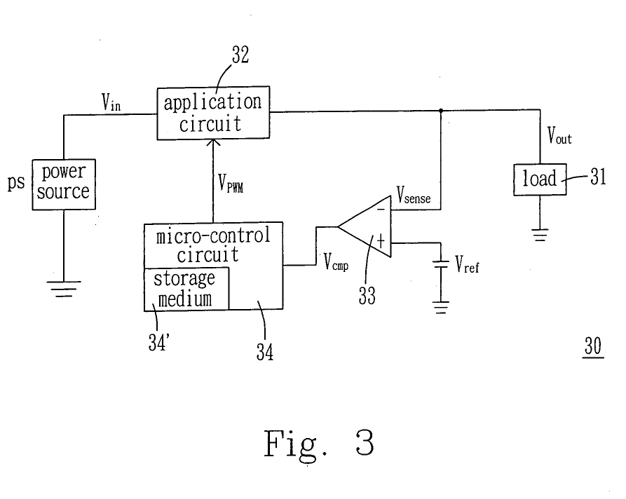

Referring to FIG. 3, a schematic diagram of the DPWM controlling system is shown therein. The DPWM controlling system comprises a load 31, an application circuit 32, a comparator 33 and a micro-control unit 34. In operation, the application circuit 32 receives a power signal Vin from a direct current (DC) power source PS and outputs a digital signal Vout to control the load 31. The comparator 33 is used to compare the output signal Vout and a reference signal Vref to generate a comparison signal Vcmp. The micro-control unit 34 is used to receive the comparison signal Vcmp to generate a DPWM signal V_{PWM} to control the application circuit 32 and thus the load 31 thereof. Alternatively, the power source PS may be an alternating current (AC) power source and the application circuit 32 may be an AC/DC control unit rather than the above described DC/DC control unit, depending on which power type PS is used. In addition, an oscillation signal OSC is further inputted into the micro-control unit 34 for synchronous operation.

Specifically, the output signal Vout from the load 32 is first detected as a sense signal Vsense. Next, the sense signal Vsene is transmitted to the comparator 33 to be compared with the reference signal Vref so as to generate the comparison signal Vcmp. Upon being powered, the micro-control unit 34 outputs a trigger signal Trigger having a pulse width of a minimum value. Thereafter, the micro-control unit 34 receives and refers to the comparison signal Vcmp and adjusts the pulse width of the trigger signal Trigger based on the comparison signal Vcmp to a larger or equal pulse width. As such, a PWM signal having the pulse width greater than or equal to the minimum value is generated to control the application circuit 32 and the load 31 thereof. The oscillation signal OSC is inputted for synchronous running of the PWM signal VPWM and the trigger signal Trigger. Namely, the comparator 33 and the micro-control unit 34 are disposed at a feedback path and the application circuit 32 and thus the load 31 thereof are controlled by the feedback technology.

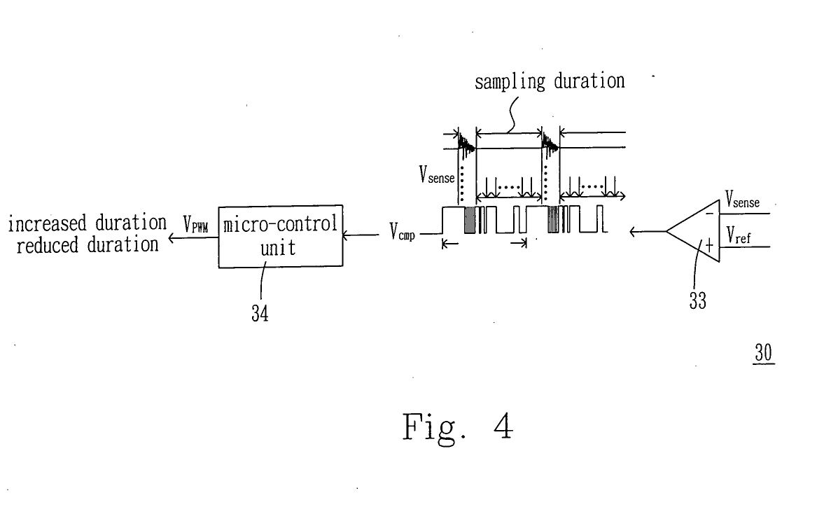

Referring now to FIG. 4, through which how the comparison signal Vcmp is referred to so as to generate an appropriate PWM signal VPWM is illustrated. At first, the comparison signal Vcmp is sampled at a specific duration. Then, the sampled signal levels are processed. If a number of times of high level is greater than that of low level occurring on the sampled signal within the sampling duration, the pulse width of the trigger signal Trigger is continuously driven to be larger by the micro-control unit 34. Otherwise, the pulse width of the trigger signal Trigger is continuously driven to be smaller by the micro-control unit 34. In this manner, the pulse width of the PWM signal V_{PWM} is adjusted and the control of the application circuit 32 and thus the load 31 may be possible.

However, when the PWM signal V_{PWM} outputted from the micro-control unit 34 transitions from high to low, noises would present on the output signal Vout of the application circuit 32. To avoid an erroneous result of the PWM signal V_{PWM}, the sampling action is only made at a time rather than the time when the noises caused from the level transition of the PWM signal V_{PWM} are presented. This time duration when the noises occur is approximately twenty percents of the duration, from the point of time when the portion of the DPWM signal V_{PWM} begins to the point of time before the intermediate next portion of the DPWM signal V_{PWM} begins, is reached. Thus, the micro-control unit 34 begins to sample the comparison signal Vcmp when twenty percents of the duration, from the point of time when the portion of the DPWM signal V_{PWM} begins to the point of time before the intermediate next portion of the DPWM signal V_{PWM} begins, is reached. In this manner, the PWM signal V_{PWM} is generated with respect to a single cycle thereof. To generate a continuous version of the PWM signal V_{PWM}, the sampling action has to be continued as the comparison signal Vcmp lasts. It is to be noted that although the comparison signal Vcmp is shown to have a constant level, the level of the comparison signal Vcmp shifts due to loss caused by the load 31. Namely, the comparison signal Vcmp is not constant in level but has different levels.

For a DC/DC application circuit (with a DC input and a DC output), the micro-control unit 34 may be done without the trigger signal Trigger, since whether the sense signal Vsense has the noises are certainly known to the micro-control unit 34 since when the point of time when the PWM signal V_{PWM} transitions in level is controlled by itself. However, the trigger signal Trigger is indispensable to an AC/DC application circuit, since the noises presented on the analog sense signal Vsense leads to a different level of the analog sense signal Vsense. At this time, the different level signal Vsense may cause an error to the PWM signal V_{PWM} and thus the control of the load 31 is not precise enough.

In the above, the sampling action and the PWM signal V_{PWM} are both performed automatically since a dedicated software for executing them is embedded in the micro-control unit 34 at a storage medium 34′, such as a read only memory (ROM) and erasable programmable read only memory (EPROM). Although the sampling action and the PWM signal V_{PWM} may be performed by a corresponding hardware circuit, the software-based execution can be a better way owing to the speed issue. In addition, the application circuit 32 used in the controlling system 30 may typically be a voltage boost circuit, a voltage buck circuit, a voltage boost/buck circuit and the like. As a matter of fact, any other specific-purpose circuit with a variable load may be suitable. In the following, the description will be made to the voltage boost circuit, voltage buck circuit and voltage boost/buck circuit in a brief manner.

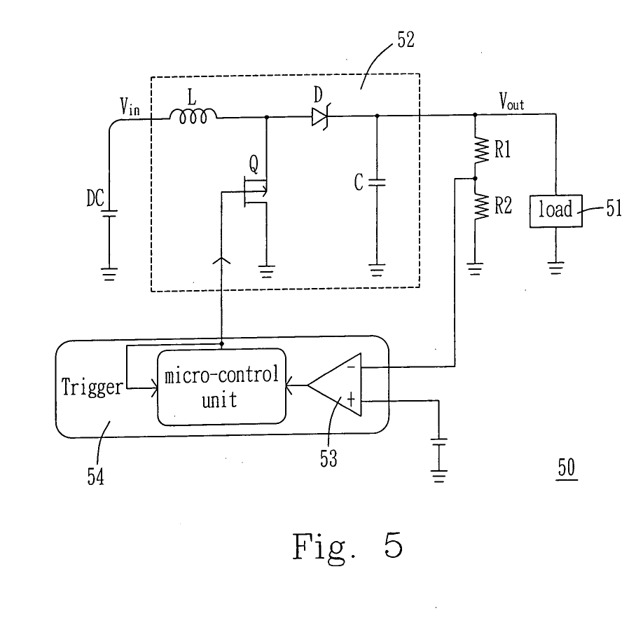

Referring to FIG. 5, a schematic circuit diagram of the DPWM controlling system with the voltage boost circuit is shown therein. As shown, a sense voltage Vsense is obtained by acquiring a specific portion of an output voltage Vout of a load 51, the specific portion being acquired by the provision of resistors R1 and R2. Then, the sense signal Vsense is compared at a comparator 53 with a reference signal Vref so as to generate a comparison signal Vcmp. Next, the comparison signal Vcmp is synchronously sampled by a micro-control unit 54 with an oscillation signal OSC. Then, a pulse width of the PWM signal V_{PWM} (the trigger signal Trigger) is modulated based on the sampled result. Finally, the adjusted PWM signal V_{PWM} is synchronously transmitted to the voltage boost circuit 52 with the oscillation signal OSC. Since the PWM signal V_{PWM} is directly transmitted to an NMOS transistor Q of the voltage boost circuit 52, noises are presented when the NMOS transistor Q switches on or off. Thus, the comparison signal Vcmp has to be sampled at a time rather than the time duration where the NMOS transistor Q switches on or off and the comparison signal Vcmp is not stable. As such, the voltage boost circuit can function normally. From FIG. 5, it may be known that the comparator 53 may be fabricated within the micro-control unit 54 to form a single chip, and thus the cost for the DPWM controlling system can be reduced.

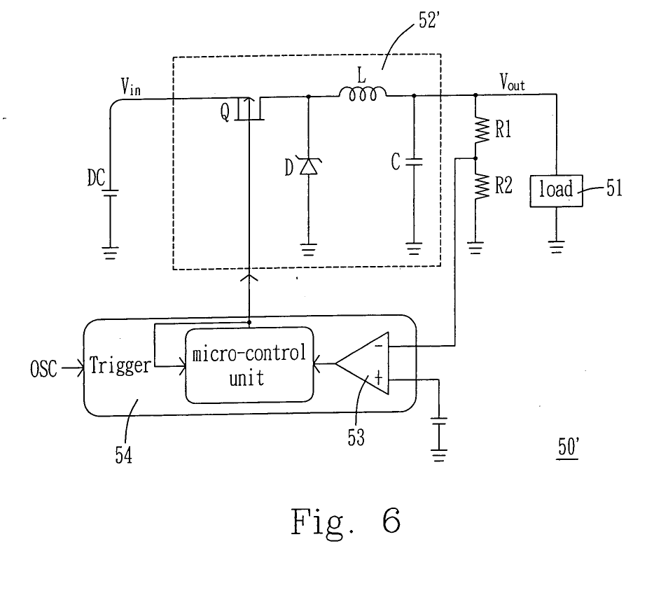

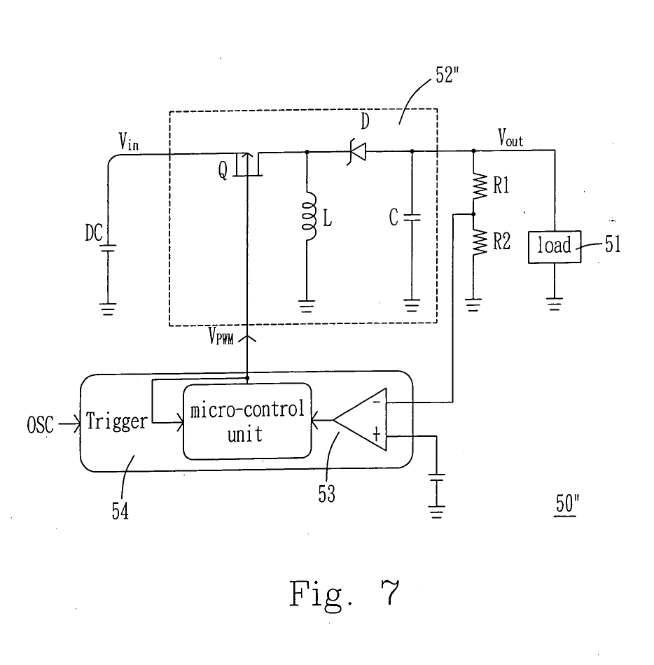

Referring to FIG. 6 and FIG. 7, the DPWM controlling systems with a voltage buck circuit and a voltage boost/buck circuit are respectively shown therein. As shown, the DPWM controlling systems 50′, 50″ are each identical to the DPWM controlling system shown in FIG. 5 in principle, except that the DPWM controlling systems 50′, 50″ are used to control the respective loads 51 of the voltage buck circuit 52′ and the voltage boost/buck circuit 52″, respectively.

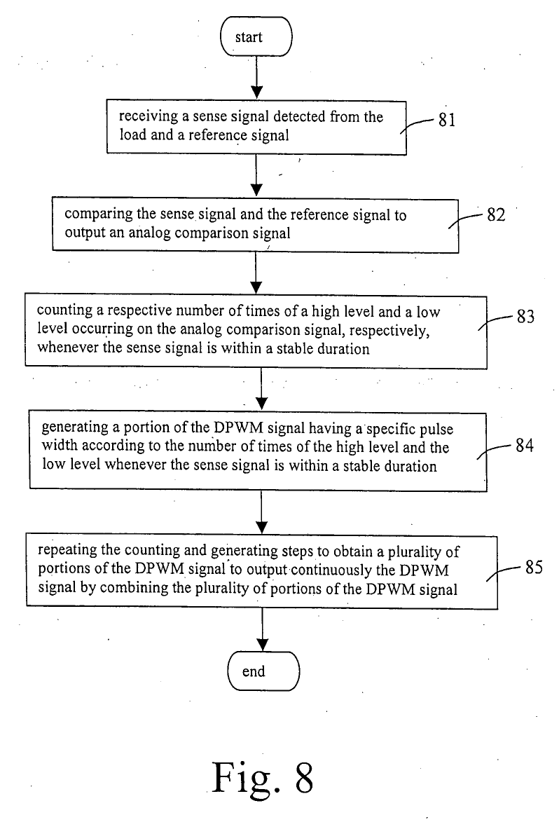

Referring to FIG. 8, a flowchart illustrating the DPWM controlling method according to the present invention is shown therein, which is used to control a load of an application with a DPWM unit. As shown, the method comprises the following steps. At first, a sense signal detected from the load and a reference signal are received (S81). Next, the sense signal is compared with the reference signal to output an analog comparison signal (S82). Then, a respective number of times of a high level and a low level occurring on the analog comparison signal is counted, respectively, whenever the sense signal is within a stable duration (S83). Thereafter, a portion of the DPWM signal having a specific pulse width according to the number of times of the high level and the low level is generated whenever the sense signal is within a stable duration (S84). Finally, the counting and generating steps are repeated to obtain a plurality of portions of the DPWM signal to output continuously the DPWM signal by combining the plurality of portions of the DPWM signal (S85).

In the method, the stable duration is a duration from a predetermined point of time after the portion of the DPWM signal begins to a point of time before an intermediate next portion of the DPWM signal begins. Preferably, the predetermined point of time is a point of time when twenty percent of the duration from the time after the portion of the DPWM signal begins to the intermediate next portion of the DPWM signal begins is reached. The step S83 comprises a step of sampling the analog comparison signal to generate the high level and the low level. The generating step comprises steps of increasing continuously the specific pulse width of the DPWM signal when the number of times of the high level is greater than the number of times of the low level, and decreasing continuously the specific pulse width of the DPWM signal when the number of times of the low level is greater than the number of times of the high level.

While the invention has been described in terms of what is presently considered to be the most practical and preferred embodiments, it is to be understood that the invention needs not be limited to the disclosed embodiments. For example, the application circuit may also be an AC/DC circuit, in addition to the described DC/DC circuit. In this case, the micro-control unit should be correspondingly designed. Accordingly, it is intended to cover various modifications and similar arrangements included within the spirit and scope of the appended claims, which are to be accorded with the broadest interpretation so as to encompass all such modifications and similar structures.

What is claimed is:

1. A digital pulse width modulation (DPWM) controlling system for controlling a load of an application circuit with a DPWM unit, comprising:
a comparator receiving a sense signal detected from the load and a reference signal and comparing the sense signal and the reference signal to output an analog comparison signal; and
a micro-control unit generating a trigger signal having a minimum pulse width and receiving the analog comparison signal to output a DPWM signal,
wherein the micro-control unit adjusts the minimum pulse width of the trigger signal to obtain a pulse width of the DPWM signal in response to the analog comparison signal whenever the sense signal is within a stable duration so as to output the DPWM signal to the application circuit to control the load.

2. The system according to claim 1, wherein the micro-control unit comprises a storage medium performing the following steps when executed:
counting a respective number of times of a high level and a low level occurring on the analog comparison signal, whenever the sense signal is within the stable duration;
generating a portion of the DPWM signal according to the respective number of times of the high level and the low level whenever the sense signal is within the stable duration; and
repeating the counting and generating steps to obtain a plurality of portions of the DPWM signal to output continuously the DPWM signal by combining the plurality of portions of the DPWM signal.

3. The system according to claim 2, wherein the stable duration is a duration from a predetermined point of time after the portion of the DPWM signal begins to a point of time before an intermediate next portion of the DPWM signal begins.

4. The system according to claim 3, wherein the predetermined point of time is a point of time when twenty percents of the duration, from the point of time when the portion of the DPWM signal begins to the point of time before the intermediate next portion of the DPWM signal begins, is reached.

5. The system according to claim 2, wherein the counting step comprising the following step:
sampling the analog comparison signal to generate the high level and the low level.

6. The system according to claim 2, wherein the generating step comprises the following steps:
increasing continuously the pulse width of the DPWM signal when the respective number of times of the high level is greater than the number of times of the low level; and
decreasing continuously the pulse width of the DPWM signal when the respective number of times of the low level is greater than the number of times of the high level.

7. The system according to claim 2, wherein the trigger signal is sent back to the micro-control unit when the DPWM signal transitions from the high level to the low level.

8. A digital pulse width modulation (DPWM) controlling method for controlling a load of an application circuit with a DPWM unit, comprising the following steps:
receiving a sense signal detected from the load and a reference signal;
comparing the sense signal and the reference signal to output an analog comparison signal;
counting a respective number of times of a high level and a low level occurring on the analog comparison signal, respectively, whenever the sense signal is within a stable duration;
generating a portion of the DPWM signal having a specific pulse width according to the number of times of the high level and the low level whenever the sense signal is within a stable duration; and
repeating the counting and generating steps to obtain a plurality of portions of the DPWM signal to output continuously the DPWM signal by combining the plurality of portions of the DPWM signal.

9. The method according to claim 8, wherein the stable duration is a duration from a predetermined point of time after the portion of the DPWM signal begins to a point of time before an intermediate next portion of the DPWM signal begins.

10. The method according to claim 9, wherein the predetermined point of time is a point of time when twenty percent of the duration from the time after the portion of the DPWM signal begins to the intermediate next portion of the DPWM signal begins is reached.

11. The method according to claim 8, wherein the counting step comprising the following steps:
sampling the analog comparison signal to generate the high level and the low level.

12. The method according to claim 8, wherein the generating step comprises the following steps:
increasing continuously the specific pulse width of the DPWM signal when the number of times of the high level is greater than the number of times of the low level; and
decreasing continuously the specific pulse width of the DPWM signal when the number of times of the low level is greater than the number of times of the high level.
